(19) United States
(12) Patent Application Publication
(10) Pub. No.: US 2022/0261476 A1
(43) Pub. Date: Aug. 18, 2022

(54) SECURITY MANAGEMENT DEVICE, SECURITY MANAGEMENT METHOD AND NON-TRANSITORY COMPUTER-READABLE MEDIUM

(71) Applicant: NEC Corporation, Minato-ku, Tokyo (JP)

(72) Inventors: Yusuke MORITA, Tokyo (JP); Takayuki SASAKI, Tokyo (JP); Toshiki KOBAYASHI, Tokyo (JP)

(73) Assignee: NEC Corporation, Minato-ku, Tokyo (JP)

(21) Appl. No.: 17/626,975

(22) PCT Filed: Jul. 22, 2019
(86) PCT No.: PCT/JP2019/028680

§ 371 Date: Jan. 13, 2022

(51) Int. Cl. G06F 21/53

(52) U.S. Cl. CPC G06F 21/53; G06F 2221/034

(57) ABSTRACT

A security management device (20) has a processing unit (21) operating in a normal environment (10A) and a processing unit (22) operating in a secure environment (10B). The processing unit (21) acquires information about an “inspection target”. The “inspection target” is a target of an inspection about normality, and programs executed in an execution environment included in the normal environment (10A) (an OS (operating system) and the like) are included. After the inspection about the normality of the inspection target based on the information about the inspection target acquired by the processing unit (21) is performed, the processing unit (22) inspects normality of the processing unit (21).

### TECHNICAL FIELD

The present disclosure relates to a security management device, a security management method and a non-transitory computer-readable medium.

### BACKGROUND ART

Techniques for verifying system integrity of an electronic device have been proposed (for example, Patent Literature 1). In the technique disclosed in Patent Literature 1, after verifying integrity of a scan module (a security function) of a normal environment (an ordinary environment), a verification module (a security function) of a secure environment causes the scan module to verify a kernel, an application or the like of the normal environment (that is, an execution environment). That is, the security function of the secure environment performs an inspection about the normality of the security function of the normal environment before the security function of the normal environment inspects the execution environment.

### CITATION LIST

### Patent Literature

Patent Literature 1: Published Japanese Translation of PCT International Publication for Patent Application, No. 2018-519705

### SUMMARY OF INVENTION

### Technical Problem

In the technique disclosed in Patent Literature 1, however, it is not considered that the security function of the normal environment may be attacked while the security function of the secure environment is inspecting the security function of the normal environment or while the security function of the normal environment is inspecting the execution environment. Therefore, an inspection result about the execution environment obtained by the security function of the normal environment operating in an abnormal state is treated as a normal inspection result, and there is a possibility that security is reduced.

An object of the present disclosure is to provide a security management device capable of improving security, a security management method and a non-transitory computer readable medium.

### Solution to Problem

A security management device according to a first aspect is a security management device configured to manage security of a processing device having a normal environment and a secure environment, the security management device including:

first processing means for acquiring information about an inspection target including a program executed in an execution environment included in the normal environment, the inspection target being a target of an inspection about normality, the first processing means operating in the normal environment; and

second processing means for inspecting normality of the first processing means after the inspection about normality of the inspection target based on the acquired information about the inspection target is performed, the second processing means operating in the secure environment.

A security management method according to a second aspect is a security management method executed by a security management device configured to manage security of a processing device having a normal environment and a secure environment, wherein

first processing means of the security management device operating in the normal environment acquires information about an inspection target including a program executed in an execution environment included in the normal environment, the inspection target being a target of an inspection about normality; and

second processing means of the security management device operating in the secure environment inspects normality of the first processing means after the inspection about the normality of the inspection target based on the acquired information about the inspection target is performed.

A non-transitory computer-readable medium according to a third aspect is a non-transitory computer-readable medium storing a program, the program causing a security management device configured to manage security of a processing device having a normal environment and a secure environment to execute the processes of:

first processing means of the security management device operating in the normal environment acquiring information about an inspection target including a program executed in an execution environment included in the normal environment, the inspection target being a target of an inspection about normality; and

second processing means of the security management device operating in the secure environment inspecting normality of the first processing means after the inspection about the normality of the inspection target based on the acquired information about the inspection target is performed.

### Advantageous Effects of Invention

By the present disclosure, it is possible to provide a security management device capable of improving security, a security management method and a non-transitory computer readable medium.

### BRIEF DESCRIPTION OF DRAWINGS

FIG. 1 is a block diagram showing an example of an electronic apparatus including a processing device in a first example embodiment;

FIG. 2 is a block diagram showing an example of the processing device (a processor) in the first example embodiment;

FIG. 3 is a block diagram showing an example of a security management device in a second example embodiment;

FIG. 4 is a block diagram showing an example of a processing device including a security management device in a third example embodiment;

FIG. 5 is a diagram showing an example of a processing operation of the security management device in the third example embodiment;

FIG. 6 is a diagram showing an example of a processing operation of a security management device in a fourth example embodiment;

FIG. 7 is a diagram showing an example of a processing operation of a security management device in a fifth example embodiment; and

FIG. 8 is a diagram showing an example of a processing operation of a security management device in a sixth example embodiment.

### DESCRIPTION OF EMBODIMENTS

Example embodiments will be explained below with reference to drawings. In the example embodiments, the same or similar components are given the same reference sign, and duplicated explanation will be omitted. Further, in the example embodiments, the same or similar processing steps are given the same reference sign, and duplicated explanation will be omitted.

### First Example Embodiment

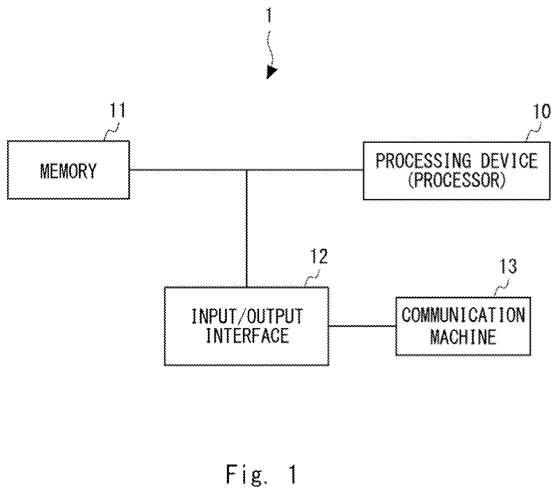

FIG. 1 is a block diagram showing an example of an electronic apparatus including a processing device in a first example embodiment. In FIG. 1, an electronic apparatus 1 has a processing device (a processor) 10, a memory 11, an input/output interface 12 and a communication machine 13.

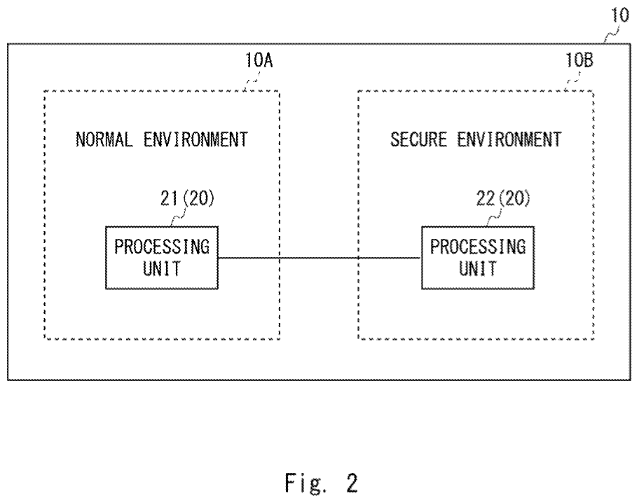

FIG. 2 is a block diagram showing an example of the processing device (a processor) in the first example embodiment. In FIG. 2, the processing device (the processor) 10 has a virtual processor (a normal environment (an ordinary environment)) 10A and a virtual processor (a secure environment) 10B. The normal environment 10A corresponds to REE (Rich Execution Environment), and the secure environment 10B corresponds to TEE (Trusted Execution Environment). For example, TEE is provided as Trust Zone in the processor architecture of ARM (Advanced RISC Machines) and is provided as SGX (Software Guard Extensions) in the processor architecture of Intel Corporation.

In FIG. 2, a security management device 20 manages security of the processing device 10 having the normal environment 10A and the secure environment 10B. For example, the security management device 20 has a processing unit (a security function) 21 and a processing unit (a security function) 22. The processing unit 21 operates in the normal environment 10A, and the processing unit 22 operates in the secure environment 10B. Hereinafter, a processing unit operating in the normal environment 10A may be called a “first processing unit”, and a processing unit operating in the secure environment 10B may be called a “second processing unit”.

The processing unit 21 acquires, from an “inspection target (not shown)”, information about the inspection target. The “inspection target” is a target of an inspection about normality, and programs executed in an “execution environment” included in the normal environment 10A (an OS (operating system) and the like) are included. The processing unit 21 may acquire the information about the inspection target not from the inspection target but through an API of the OS. Further, the processing unit 21 may access the memory 11 to acquire the information about the inspection target from the memory 11. Here, the information about the inspection target is, for example, execution states of an execution code of a program stored in a memory or a storage, a configuration file of the program, internal variables of the program stored on the memory.

After an inspection about the normality of the inspection target based on the information about the inspection target acquired by the processing unit 21 is performed, the processing unit 22 inspects the normality of the processing unit 21.

As described above, according to the first example embodiment, the security management device 20 has the processing unit (the security function) 21 operating in the normal environment 10A and the processing unit (the security function) 22 operating in the secure environment 10B. The processing unit 21 acquires information about an “inspection target (not shown)”. The “inspection target” is a target of an inspection about normality and includes programs executed in the execution environment included in the normal environment 10A (the OS (operating system) and the like). After an inspection about the normality of the inspection target based on the information about the inspection target acquired by the processing unit 21 is performed, the processing unit 22 inspects the normality of the processing unit 21.

According to the configuration of the security management device 20, the normality of the processing unit 21 is inspected after the inspection about the normality of the inspection target based on the information about the inspection target acquired by the processing unit 21 is performed, and, therefore, an inspection result showing the processing unit 21 being normal or abnormal at the time point when the inspection about the normality of the inspection target is performed can be obtained. The inspection result showing the processing unit 21 being normal or abnormal can be a judgment indicator for reliability (validity) of a result of the inspection about the normality of the inspection target. Therefore, for example, if an inspection result showing the processing unit 21 being abnormal is obtained, the result of the inspection about the normality of the inspection target can be treated as an inspection result with a low reliability, and it is possible to improve security.

The inspection about the normality of the processing unit 21 may be performed not only after the inspection about the normality of the inspection target based on the information about the inspection target acquired by the processing unit 21 but may be performed before and after the inspection about the normality of the inspection target is performed in a series of procedures. Thereby, it is possible to further improve security. Hereinafter, the inspection about the normality of the processing unit 21 that is performed before the inspection about the normality of the inspection target described above may be simply called a “pre-inspection”. Further, hereinafter, the inspection about the normality of the processing unit 21 that is performed after the inspection about the normality of the inspection target described above may be simply called a “post-inspection”.

Further, the processing unit 22 may execute the “pre-inspection” described above, with the current timing being a regular inspection execution timing as an “execution trigger”.

### Second Example Embodiment

A second example embodiment relates to a specific example of an inspection about the normality of the first processing unit.

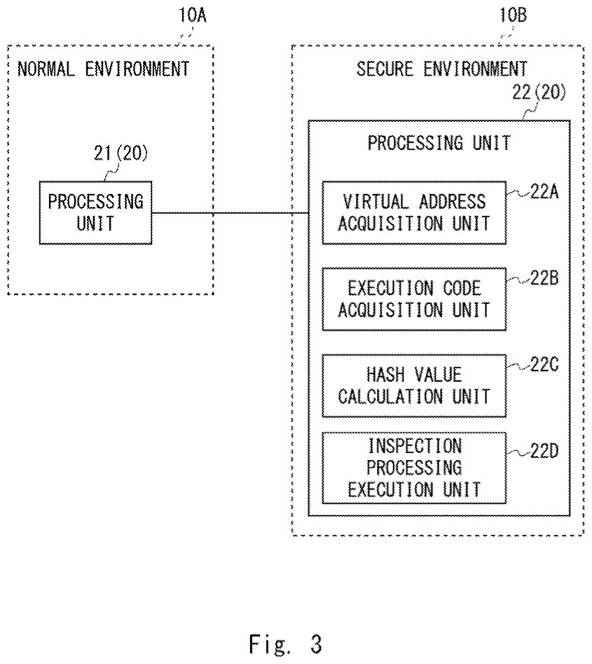

FIG. 3 is a block diagram showing an example of a security management device in the second example embodiment. In FIG. 3, the security management device 20 has the processing unit 21 and the processing unit 22. The processing unit 22 has a virtual address acquisition unit 22A, an execution code acquisition unit 22B, a hash value calculation unit 22C and an inspection processing execution unit 22D.

The virtual address acquisition unit 22A acquires a second virtual address which shows a memory area where an operation program of the processing unit 21 is stored in the memory 11 and which is used by the processing unit 21, the second virtual address corresponding to a first virtual address which shows the memory area and is used by the processing unit 21. For example, the processing unit 21 sends a physical address obtained by converting the first virtual address described above to the processing unit 22. Then, the virtual address acquisition unit 22A acquires the second virtual address described above by converting (mapping) the physical address sent from the processing unit 21 to the second address described above. Thereby, even if address spaces of the processing units 21 and 22 are different, the execution code acquisition unit 22B can certainly access the memory area described above. The conversion from the physical address to the second virtual address described above may be omitted in the case of an OS or a processor capable of accessing a memory directly using a physical address.

The execution code acquisition unit 22B accesses the memory area described above using the second virtual address acquired by the virtual address acquisition unit 22A (that is, scans the memory area described above) to acquire an execution code of the operation program of the processing unit 21.

The hash value calculation unit 22C calculates a hash value of the execution code based on the execution code acquired by the execution code acquisition unit 22B. An algorithm used for the calculation of the hash value is not especially limited and may be, for example, SHA1, SHA256 or the like.

The inspection processing execution unit 22D holds a correct hash value of the execution code of the operation program of the processing unit 21. The correct hash value may be calculated at the time of developing the processing device 10 and held in the inspection processing execution unit 22D or may be calculated by the hash value calculation unit 22C at startup of the processing device 10 and held in the inspection processing execution unit 22D. Since the inspection processing execution unit 22D operating in the secure environment 10B holds the correct hash value as described above, it is possible to prevent the correct hash value from being tampered with.

Then, the inspection processing execution unit 22D inspects the normality of the processing unit 21 based on the hash value calculated by the hash value calculation unit 22C and the correct hash value. For example, the inspection processing execution unit 22D judges that the processing unit 21 is normal (not tampered) if the hash value calculated by the hash value calculation unit 22C and the correct value match, and judges that the processing unit 21 is abnormal (tampered) if the two hash values do not match. By using the hash values as described above, it is possible to accurately inspect the normality of the processing unit 21.

If a result of a “post-inspection” of the processing unit 21 shows the processing unit 21 being abnormal, the processing unit 22 may discard a result of an inspection about the normality of an inspection target irrespective of the content of the result of the inspection.

### Third Example Embodiment

A third example embodiment relates to variation of the “execution trigger” described above. Since the configuration of an electronic apparatus in the third example embodiment is the same as the configuration of the electronic apparatus 1 of the first and second example embodiments, FIG. 1 will be referred to.

### <Configuration Example of Security Management Device>

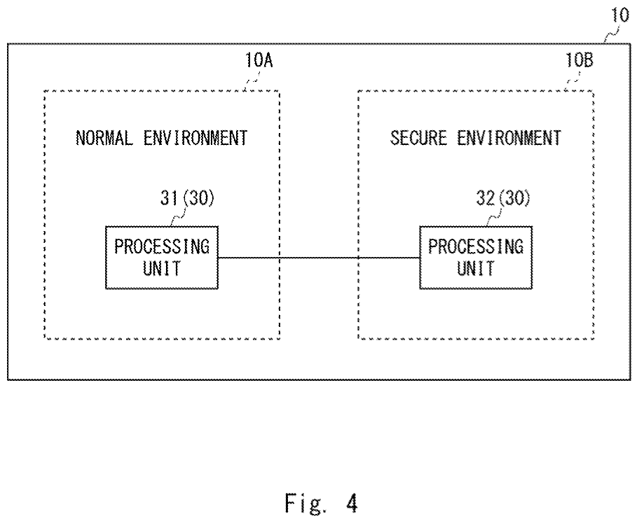

FIG. 4 is a block diagram showing an example of a processing device including a security management device in the third example embodiment. In FIG. 4, a security management device 30 has a processing unit (a first processing unit) 31 and a processing unit (a second processing unit) 32. The processing units 31 and 32 perform processes similar to those of the processing units 21 and 22 in the first and second example embodiments.

The processing unit 31 sends an “inspection request” to the processing unit 32 when detecting a particular event of an inspection target by monitoring the inspection target. The particular event may be, for example, starting of a process, opening of a file or the like. Or alternatively, the processing unit 31 may send the “inspection request” to the processing unit 32 when the current timing is a regular inspection request timing.

Further, when receiving a “request for an inspection of the inspection target” from the processing unit 32, the processing unit 31 sends an “information sending request” to the inspection target. In response to the information sending request, the inspection target sends information about the inspection target to the processing unit 31. Further, the processing unit 31 may acquire the information about the inspection target not from the inspection target but from the API of the OS or a memory.

Further, when acquiring the information about the inspection target sent from the inspection target, the processing unit 31 inspects the normality of the inspection target based on the information and sends a result of the inspection to the processing unit 32.

The processing unit 32 executes a “pre-inspection” of the processing unit 31, with receiving of the “inspection request” from the processing unit 31 as an execution trigger.

Further, if a result of the “pre-inspection” of the processing unit 31 shows the processing unit 31 being normal, the processing unit 32 sends the “request for an inspection of the inspection target” to the processing unit 31. If the result of the inspection about the normality of the processing unit 31 shows the processing unit 31 being abnormal, the processing unit 32 may execute, for example, control to restrict a processing operation in the normal environment 10A.

Further, when receiving a result of the inspection about the normality of the inspection target sent from the processing unit 31, the processing unit 32 executes a “post-inspection” of the processing unit 31.

Then, the processing unit 32 executes a process corresponding to a result of the “post-inspection” of the processing unit 31. For example, if the result of the “post-inspection” of the processing unit 31 shows the processing unit 31 being abnormal, the processing unit 32 may discard the result of the inspection of the inspection target received from the processing unit 31 irrespective of the content of the result of the inspection. Then, the processing unit 32 may execute, for example, control to restrict the processing operation in the normal environment 10A.

### <Operation Example of Security Management Device>

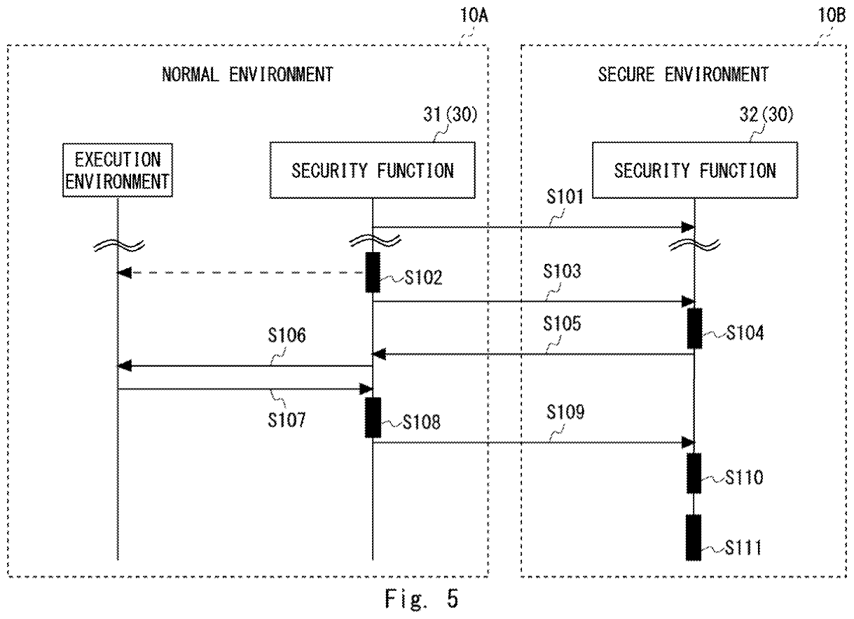

An example of a processing operation of the security management device 30 having the above configuration will be explained. FIG. 5 is a diagram showing an example of a processing operation of the security management device in the third example embodiment. FIG. 5 shows a series of procedures, and the series of procedures are repeatedly executed.

The processing unit (a security function) 31 sends address information showing a memory area in the memory 11 where an operation program of the processing unit 31 is stored to the processing unit (a security function) 32 (step S101). The sent address information is, for example, the physical address explained in the second example embodiment.

The processing unit 31 always monitors the execution environment (an inspection target) of a program such as the OS (step S102).

When detecting a particular event of the inspection target, the processing unit 31 sends an “inspection request” to the processing unit 32 (step S103).

When receiving the “inspection request” from the processing unit 31, the processing unit 32 execute an inspection about the normality of the processing unit 31 (step S104).

When a result of the inspection about the normality of the processing unit 31 shows the processing unit 31 being normal, the processing unit 32 sends a “request for an inspection of the inspection target” to the processing unit 31 (step S105).

When receiving the “request for an inspection of the inspection target” from the processing unit 32, the processing unit 31 sends an “information sending request” to the inspection target (step S106). Further, the processing unit 31 may acquire the information about the inspection target not from the inspection target but from the API of the OS or a memory.

When receiving the “information sending request” from the processing unit 31, the inspection target sends information about the inspection target to the processing unit 31 (step S107). If the processing unit 31 calls the API of the OS at step 106, the OS sends the information about the inspection target to the processing unit 31 at step S107.

When acquiring the information about the inspection target sent from the inspection target, the processing unit 31 inspects the normality of the inspection target based on the information (step S108) and sends a result of the inspection to the processing unit 32 (step S109).

When receiving the result of the inspection about the normality of the inspection target from the processing unit 31, the processing unit 32 executes the inspection about the normality of the processing unit 31 again (step S110).

The processing unit 32 executes a process corresponding to a result of the inspection about the normality of the processing unit 31 performed at step S110 (step S111).

Though, in the above explanation, the explanation has been made on the assumption that the processing unit 31 sends address information to the processing unit 32 only once before an inspection about the normality of the processing unit 31 by the processing unit 32, the present example embodiment is not limited thereto. For example, each time the inspection about the normality of the processing unit 31 by the processing unit 32 is performed, the processing unit 31 may send address information to the processing unit 32 before the inspection. For example, if the memory area of the operation program of the processing unit 31 changes, the processing unit 31 can send address information for each inspection. If the memory area does not change, the processing unit 31 can send address information only once before the first inspection.

### Fourth Example Embodiment

A fourth example embodiment relates to variation of a trigger for an “inspection request” being sent. Since the configuration of an electronic apparatus in the fourth example embodiment is the same as the configuration of the electronic apparatus 1 of the first and second example embodiments, FIG. 1 will be referred to. Further, since the configuration of a security management device in the fourth example embodiment is the same as that of the security management device 30 of the third example embodiment, explanation will be made with reference to FIG. 4. Hereinafter, points in which the fourth example embodiment is different from the third example embodiment will be mainly explained.

### <Configuration Example of Security Management Device>

In the security management device 30 of the fourth example embodiment, the processing unit 31 sends an “inspection request” to the processing unit 32 when receiving an “execution permission request” from an inspection target. That is, the processing unit 31 of the fourth example embodiment is different in the trigger for sending the “inspection request” to the processing unit 32 when compared with the third example embodiment.

Further, when receiving an “execution permission” from the processing unit 32, the processing unit 31 sends the received execution permission to the execution environment (the inspection target).

The processing unit 32 executes a process corresponding to a result of a “post-inspection” of the processing unit 31. For example, when a “permission condition” is satisfied, the processing unit 32 sends the “execution permission” to the processing unit 31. The “permission condition” is, for example, that a result of a “post-inspection” of the processing unit 31 shows the processing unit 31 being normal, and a result of an inspection sent from the processing unit 31 shows an inspection target being normal.

### <Operation Example of Security Management Device>

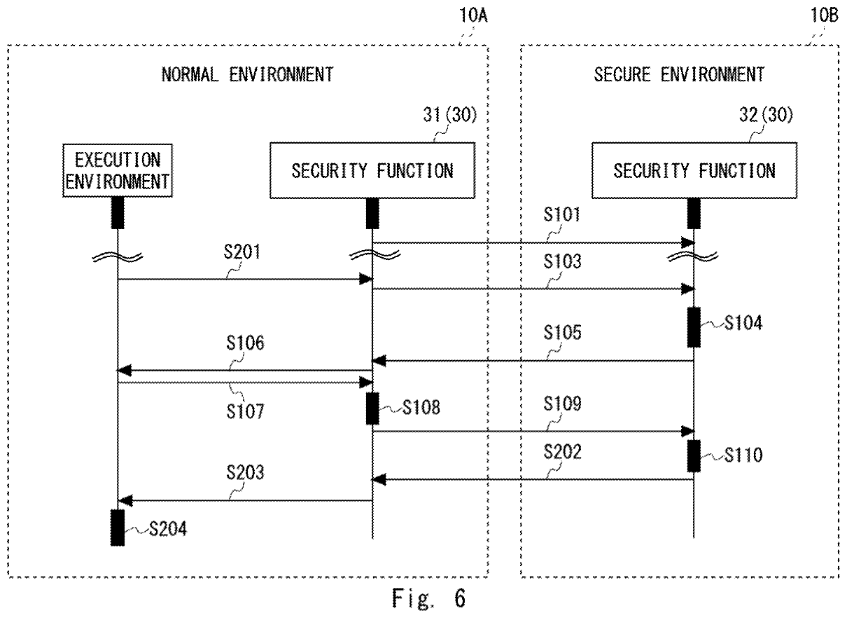

An example of a processing operation of the security management device 30 having the above configuration will be explained. FIG. 6 is a diagram showing an example of a processing operation of the security management device in the fourth example embodiment. FIG. 6 shows a series of procedures, and the series of procedures are repeatedly executed.

An inspection target sends an “execution permission request” for a particular function to the processing unit 31 at a stage before executing the particular function (step S201). When receiving the execution permission request, the processing unit 31 sends an “inspection request” to the processing unit 32 (step S103).

When the “permission condition” described above is satisfied, the processing unit 32 sends an “execution permission” to the processing unit 31 (step S202).

When receiving the “execution permission” from the processing unit 32, the processing unit 31 sends the execution permission to the inspection target (step S203).

When receiving the execution permission via the processing unit 31, the inspection target executes the particular function described above (step S204).

### Fifth Example Embodiment

A fifth example embodiment relates to variation of the “execution trigger” described above. Since the configuration of an electronic apparatus in the fifth example embodiment is the same as the configuration of the electronic apparatus 1 of the first and second example embodiments, FIG. 1 will be referred to. Further, since the configuration of a security management device in the fifth example embodiment is the same as that of the security management device 30 of the third example embodiment, explanation will be made with reference to FIG. 4. Hereinafter, points in which the fifth example embodiment is different from the third example embodiment will be mainly explained.

### <Configuration Example of Security Management Device>

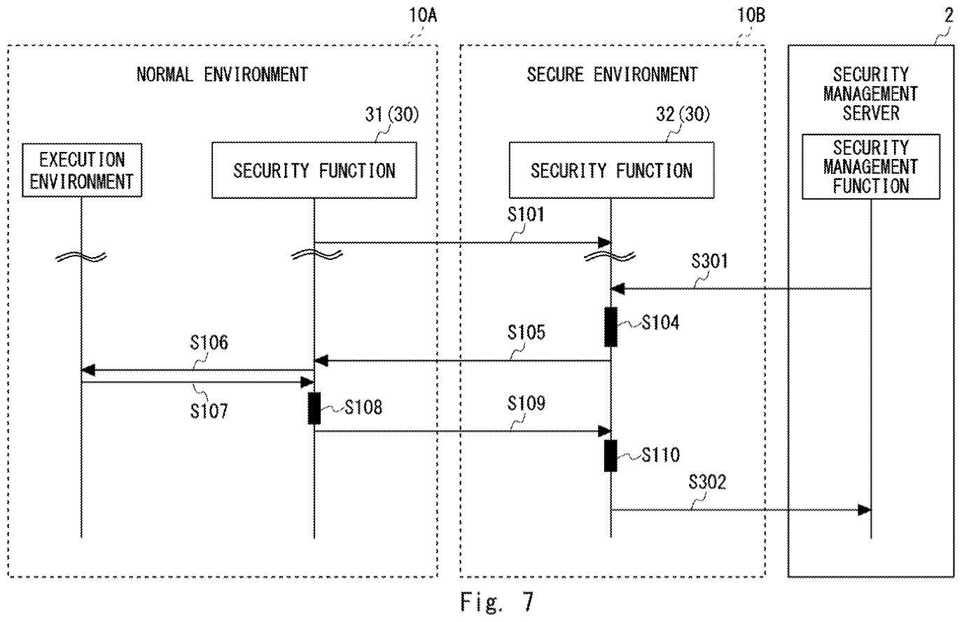

In the security management device 30 of the fifth example embodiment, the processing unit 32 executes a “pre-inspection” of the processing unit 31, with receiving of a “request for an inspection of an inspection target” from a security management server 2 (see FIG. 7) existing outside the electronic apparatus 1 as an execution trigger.

If a result of the “pre-inspection” of the processing unit 31 shows the processing unit 31 being normal, the processing unit 32 sends the “request for an inspection of an inspection target” to the processing unit 31. If a result of the inspection about the normality of the processing unit 31 shows the processing unit 31 being abnormal, the processing unit 32 may execute, for example, control to restrict a processing operation in the normal environment 10A. In this case, the processing unit 32 may report the result of the inspection about the normality of the processing unit 31 to the security management server 2. The report is transmitted via the communication machine 13 shown in FIG. 1.

Further, when receiving a result of an inspection about the normality of the inspection target sent from the processing unit 31, the processing unit 32 executes a “post-inspection” of the processing unit 31.

Then, the processing unit 32 reports results of the inspection about the normality of the processing unit 31 performed before and after the inspection about the normality of the inspection target is performed (that is, the results of the “pre-inspection” and the “post-inspection) and the result of the inspection sent from the processing unit 31 to the security management server 2. The report is transmitted via the communication machine 13 shown in FIG. 1.

### <Operation Example of Security Management Device>

An example of a processing operation of the security management device 30 having the above configuration will be explained. FIG. 7 is a diagram showing an example of a processing operation of the security management device in the fifth example embodiment. FIG. 7 shows a series of procedures, and the series of procedures are repeatedly executed.

A security management function of the security management server 2 transmits a “request for an inspection of an inspection target” to the electronic apparatus 1 (step S301). For example, the electronic apparatus 1 and the security management server 2 are connected via a network, and the “request for an inspection of an inspection target” may be transmitted to the electronic apparatus 1 via the network. The “request for an inspection of an inspection target” is received by the communication machine 13 of the electronic apparatus 1, and received by the processing unit 32 via the input/output interface 12.

The processing unit 32 transmits results of inspections about the normality of the processing unit 31 obtained at steps S104 and S110, and a result of an inspection transmitted from the processing unit 31 at step S109 to the security management server 2 (step S302).

Though explanation has been made on the assumption that the processing unit 32 reports results of a “pre-inspection” and a “post-inspection” of the processing unit 31 and a result of an inspection sent from the processing unit 31 to the security management server 2 in the above explanation, the present example embodiment is not limited thereto. For example, the processing unit 32 may report the result of the “post-inspection” of the processing unit 31 and the result of the inspection sent from the processing unit 31 to the security management server 2. That is, the result of the “pre-inspection” of the processing unit 31 may not be reported.

### Sixth Example Embodiment

In the third to fifth example embodiments, explanation has been made on the assumption that the processing unit 31 (the first processing unit) executes an inspection about the normality of an inspection target and transmits an inspection result to the processing unit 32 (the second processing unit). In a sixth example embodiment, the first processing unit sends information about an inspection target received from the inspection target to the second processing unit without performing an inspection about the normality of the inspection target. Then, the second processing unit executes the inspection about the normality of the inspection target based on the information about the inspection target received from the first processing unit. The method of the sixth example embodiment is applicable to any of the third to fifth example embodiments. Here, explanation will be made on a case where the method is applied to the third example embodiment as an example. Since the configuration of an electronic apparatus in the sixth example embodiment is the same as the configuration of the electronic apparatus 1 of the first and second example embodiments, FIG. 1 will be referred to. Further, since the configuration of a security management device in the sixth example embodiment is the same as that of the security management device 30 of the third example embodiment, explanation will be made with reference to FIG. 4. Hereinafter, points in which the sixth example embodiment is different from the third example embodiment will be mainly explained.

### <Configuration Example of Security Management Device>

In the security management device 30 of the sixth example embodiment, when acquiring information about an inspection target sent from the inspection target, the processing unit 31 sends the information to the processing unit 32. Further, the processing unit 31 may acquire the information about the inspection target not from the inspection target but from the API of the OS or a memory.

In the security management device 30 of the sixth example embodiment, when acquiring the information about the inspection target from the processing unit 31, the processing unit 32 inspects the normality of the inspection target based on the information. Then, the processing unit 32 executes an inspection about the normality of the processing unit 31 again.

### <Operation Example of Security Management Device>

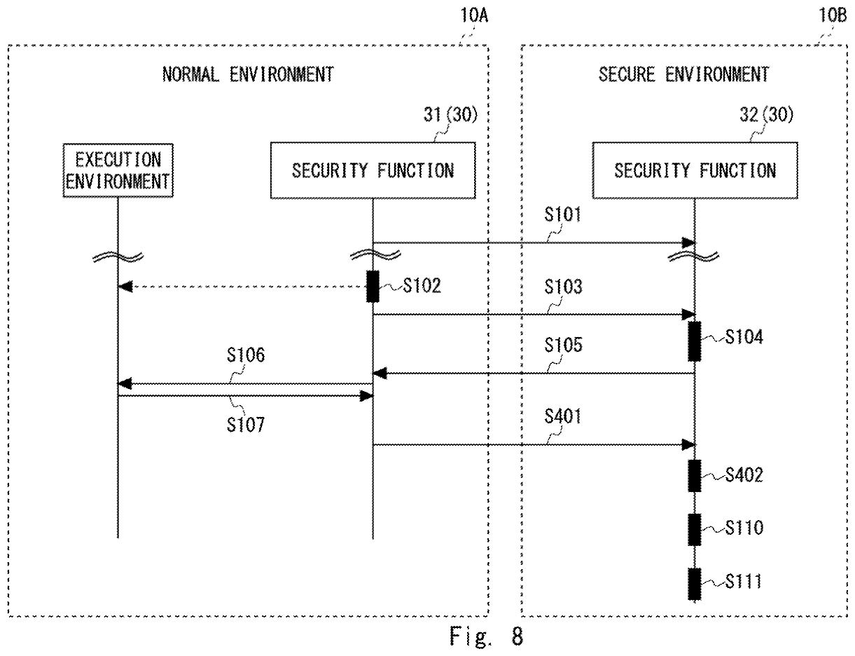

FIG. 8 is a diagram showing an example of a processing operation of the security management device in the sixth example embodiment. FIG. 8 shows a series of procedures, and the series of procedures are repeatedly executed.

When acquiring information about an inspection target sent from the inspection target, the processing unit 31 sends the information to the processing unit 32 (step S401).

When acquiring the information about the inspection target from the processing unit 31, the processing unit 32 inspects the normality of the inspection target based on the information (step S402). Then, the processing unit 32 executes an inspection about the normality of the processing unit 31 again (step S110).

### Other Example Embodiments

As shown in FIG. 1, the electronic apparatus 1 has the processor 10 and the memory 11 as described above. The processor 10 may be, for example, a microprocessor, an MPU (micro-processing unit) or a CPU (central processing unit). The processor 10 may include a plurality of processors. The memory 11 is configured with a combination of a volatile memory and a non-volatile memory. As the memory 11, a storage arranged away from the processor 10 may be included. In this case, the processor 10 may access the memory 11 via the input/output interface 12.

The processing units 21, 22, 31 and 32 of the security management devices 20 and 30 of the first to sixth example embodiments may be realized by the processor 10 reading and executing the program stored in the memory 11. The program can be stored in various types of non-transitory computer-readable media to be provided for the security management devices 20 and 30. Examples of the non-transitory computer-readable media include magnetic recording media (for example, a flexible disk, a magnetic tape and a hard disk drive) and a magneto-optical recording media (for example, a magneto-optical disk). Furthermore, examples of the non-transitory computer-readable media include a CD-ROM (read-only memory), a CD-R and a CD-R/W. Furthermore, examples of the non-transitory computer-readable media include semiconductor memories. The semiconductor memories include, for example, a mask ROM, a PROM (programmable ROM), an EPROM (erasable PROM), a flash ROM and a RAM (random access memory). Further, the program may be provided for the security management devices 20 and 30 by various types of transitory computer-readable media. Examples of the transitory computer-readable media include an electric signal, an optical signal and an electromagnetic wave. The transitory computer-readable media can provide the program for the security management devices 20 and 30 via a wired communication channel such as an electric wire and an optical fiber or a wireless communication channel.

The invention of the present application has been explained with reference to example embodiments. The invention of the present application, however, is not limited to the above. Various changes that one skilled in the art can understand within the scope of the invention can be made in the configurations and details of the invention of the present application.

Part or all of the above example embodiments can be written like the supplementary notes below but are not limited thereto.

### [Supplementary Note 1]

A security management device configured to manage security of a processing device having a normal environment and a secure environment, the security management device comprising:

first processing means for acquiring information about an inspection target including a program executed in an execution environment included in the normal environment, the inspection target being a target of an inspection about normality, the first processing means operating in the normal environment; and

second processing means for inspecting normality of the first processing means after the inspection about the normality of the inspection target based on the acquired information about the inspection target is performed, the second processing means operating in the secure environment.

### [Supplementary Note 2]

The security management device according to Supplementary Note 1, wherein the second processing means comprises:

virtual address acquisition means for acquiring a second virtual address which shows a memory area where an operation program of the first processing means is stored in a memory and which is used by the second processing means, the second virtual address corresponding to a first virtual address which shows the memory area and is used by the first processing means;

execution code acquisition means for accessing the memory area using the acquired second virtual address to acquire an execution code of the operation program;

hash value calculation means for, based on the acquired execution code, calculating a hash value of the execution code; and

inspection processing execution means for inspecting the normality of the first processing means based on the calculated hash value and a correct hash value of the execution code.

### [Supplementary Note 3]

The security management device according to Supplementary Note 2, wherein

the first processing means sends a physical address obtained by converting the first virtual address to the second processing means; and

the virtual address acquisition means converts the physical address sent from the first processing means to the second virtual address.

### [Supplementary Note 4]

The security management device according to any one of Supplementary Notes 1 to 3, wherein the second processing means further inspects the normality of the first processing means before the inspection about the normality of the inspection target is performed.

### [Supplementary Note 5]

The security management device according to Supplementary Note 4, wherein the second processing means executes the inspection about the normality of the first processing means performed before the inspection about the normality of the inspection target is performed, with a current timing being a regular inspection execution timing as an execution trigger.

### [Supplementary Note 6]

The security management device according to Supplementary Note 4, wherein the second processing means executes the inspection about the normality of the first processing means performed before the inspection about the normality of the inspection target is performed, with receiving of an inspection request from the first processing means as an execution trigger.

### [Supplementary Note 7]

The security management device according to Supplementary Note 6, wherein the first processing means sends the inspection request to the second processing means when detecting a particular event of the inspection target by monitoring the inspection target or when a current timing is a regular inspection request timing.

### [Supplementary Note 8]

The security management device according to any one of Supplementary Notes 1 to 7, wherein

the first processing means inspects the normality of the inspection target based on the acquired information about the inspection target and sends a result of the inspection to the second processing means; and

if a result of the inspection about the normality of the first processing means performed after the inspection about the normality of the inspection target is performed shows the first processing means being abnormal, the second processing means discards the result of the inspection sent from the first processing means irrespective of content of the result of the inspection.

### [Supplementary Note 9]

The security management device according to Supplementary Note 6, wherein the first processing means sends the inspection request to the second processing means when receiving an execution permission request from the inspection target.

### [Supplementary Note 10]

The security management device according to Supplementary Note 9, wherein

the first processing means inspects the normality of the inspection target based on the acquired information about the inspection target and sends a result of the inspection to the second processing means; and

if a result of the inspection about the normality of the first processing means performed after the inspection about the normality of the inspection target is performed shows the first processing means being abnormal, the second processing means discards the result of the inspection sent from the first processing means irrespective of content of the result of the inspection.

### [Supplementary Note 11]

The security management device according to Supplementary Note 10, wherein, if the result of the inspection about the normality of the first processing means performed after the inspection about the normality of the inspection target is performed shows the first processing means being normal, and the result of the inspection sent from the first processing means shows the inspection target being normal, the second processing means sends execution permission to the inspection target.

### [Supplementary Note 12]

The security management device according to Supplementary Note 4, wherein the second processing means executes the inspection about the normality of the first processing means performed before the inspection about the normality of the inspection target is performed, with receiving of an inspection request from a security management server existing outside the processing device as an execution trigger.

### [Supplementary Note 13]

The security management device according to Supplementary Note 12, wherein

the first processing means inspects the normality of the inspection target based on the acquired information about the inspection target and sends a result of the inspection to the second processing means; and

the second processing means sends results of the inspection about the normality of the first processing means performed before and after the inspection about the normality of the inspection target is performed, and the result of the inspection sent from the first processing means to the security management server.

### [Supplementary Note 14]

The security management device according to any one of Supplementary Notes 1 to 7, wherein

the first processing means sends the acquired information about the inspection target to the second processing means; and

the second processing means inspects the normality of the inspection target based on the information about the inspection target sent from the first processing means, and, if a result of the inspection about the normality of the first processing means performed after the inspection about the normality of the inspection target is performed shows the first processing means being abnormal, discards a result of the inspection about the normality of the inspection target irrespective of content of the result of the inspection.

### [Supplementary Note 15]

The security management device according to Supplementary Note 9, wherein

the first processing means sends the acquired information about the inspection target to the second processing means; and

the second processing means inspects the normality of the inspection target based on the information about the inspection target sent from the first processing means, and, if a result of the inspection about the normality of the first processing means performed after the inspection about the normality of the inspection target is performed shows the first processing means being abnormal, discards a result of the inspection about the normality of the inspection target irrespective of content of the result of the inspection.

### [Supplementary Note 16]

The security management device according to Supplementary Note 15, wherein, if the result of the inspection about the normality of the first processing means performed after the inspection about the normality of the inspection target is performed shows the first processing means being normal, and the result of the inspection about the normality of the inspection target shows the inspection target being normal, the second processing means sends execution permission to the inspection target.

### [Supplementary Note 17]

The security management device according to Supplementary Note 12, wherein

the first processing means sends the acquired information about the inspection target to the second processing means; and

the second processing means inspects the normality of the inspection target based on the information about the inspection target sent from the first processing means, and sends results of the inspection about the normality of the first processing means performed before and after the inspection about the normality of the inspection target is performed and a result of the inspection about the normality of the inspection target to the security management server.

### [Supplementary Note 18]

A processing device comprising the security management device according to any one of Supplementary Notes 1 to 17.

### [Supplementary Note 19]

A security management method executed by a security management device configured to manage security of a processing device having a normal environment and a secure environment, wherein

first processing means of the security management device operating in the normal environment acquires information about an inspection target including a program executed in an execution environment included in the normal environment, the inspection target being a target of an inspection about normality; and

second processing means of the security management device operating in the secure environment inspects normality of the first processing means after the inspection about the normality of the inspection target based on the acquired information about the inspection target is performed.

### [Supplementary Note 20]

A non-transitory computer-readable medium storing a program, the program causing a security management device configured to manage security of a processing device having a normal environment and a secure environment to execute the processes of:

first processing means of the security management device operating in the normal environment acquiring information about an inspection target including a program executed in an execution environment included in the normal environment, the inspection target being a target of an inspection about normality; and

second processing means of the security management device operating in the secure environment inspecting normality of the first processing means after the inspection about the normality of the inspection target based on the acquired information about the inspection target is performed.

### REFERENCE SIGNS LIST

1 ELECTRONIC APPARATUS
2 SECURITY MANAGEMENT SERVER
10 PROCESSING DEVICE (PROCESSOR)
10A VIRTUAL PROCESSOR (NORMAL ENVIRONMENT)
10B VIRTUAL PROCESSOR (SECURE ENVIRONMENT)
11 MEMORY
12 INPUT/OUTPUT INTERFACE
13 COMMUNICATION MACHINE
20 SECURITY MANAGEMENT DEVICE
21 PROCESSING UNIT (FIRST PROCESSING UNIT, SECURITY FUNCTION)
22 PROCESSING UNIT (SECOND PROCESSING UNIT, SECURITY FUNCTION)
22A VIRTUAL ADDRESS ACQUISITION UNIT
22B EXECUTION CODE ACQUISITION UNIT
22C HASH VALUE CALCULATION UNIT
22D INSPECTION PROCESSING EXECUTION UNIT
30 SECURITY MANAGEMENT DEVICE
31 PROCESSING UNIT (FIRST PROCESSING UNIT, SECURITY FUNCTION)
32 PROCESSING UNIT (SECOND PROCESSING UNIT, SECURITY FUNCTION)

What is claimed is:

1. A security management device configured to manage security of a processing device having a normal environment and a secure environment, the security management device comprising:
hardware including at least one processor and at least one memory;
first processing unit implemented at least by the hardware and that acquires information about an inspection target including a program executed in an execution environment included in the normal environment, the inspection target being a target of an inspection about normality, the first processing unit operating in the normal environment; and
second processing unit implemented at least by the hardware and that inspects normality of the first processing unit after the inspection about the normality of the inspection target based on the acquired information about the inspection target is performed, the second processing unit operating in the secure environment.

2. The security management device according to claim 1, wherein the second processing unit comprises:
virtual address acquisition unit for acquiring a second virtual address which shows a memory area where an operation program of the first processing unit is stored in a memory and which is used by the second processing unit, the second virtual address corresponding to a first virtual address which shows the memory area and is used by the first processing unit;
execution code acquisition unit for accessing the memory area using the acquired second virtual address to acquire an execution code of the operation program;
hash value calculation unit for, based on the acquired execution code, calculating a hash value of the execution code; and
inspection processing execution unit for inspecting the normality of the first processing unit based on the calculated hash value and a correct hash value of the execution code.

3. The security management device according to claim 2, wherein
the first processing unit sends a physical address obtained by converting the first virtual address to the second processing unit; and
the virtual address acquisition unit converts the physical address sent from the first processing unit to the second virtual address.

4. The security management device according to claim 1, wherein the second processing unit further inspects the normality of the first processing unit before the inspection about the normality of the inspection target is performed.

5. The security management device according to claim 4, wherein the second processing unit executes the inspection about the normality of the first processing unit performed before the inspection about the normality of the inspection target is performed, with a current timing being a regular inspection execution timing as an execution trigger.

6. The security management device according to claim 4, wherein the second processing unit executes the inspection about the normality of the first processing unit performed before the inspection about the normality of the inspection target is performed, with receiving of an inspection request from the first processing unit as an execution trigger.

7. The security management device according to claim 6, wherein the first processing unit sends the inspection request to the second processing unit when detecting a particular event of the inspection target by monitoring the inspection target or when a current timing is a regular inspection request timing.

8. The security management device according to claim 1, wherein
the first processing unit inspects the normality of the inspection target based on the acquired information about the inspection target and sends a result of the inspection to the second processing unit; and
if a result of the inspection about the normality of the first processing unit performed after the inspection about the normality of the inspection target is performed shows the first processing unit being abnormal, the second processing unit discards the result of the inspection sent from the first processing unit irrespective of content of the result of the inspection.

9. The security management device according to claim 6, wherein the first processing unit sends the inspection request to the second processing unit when receiving an execution permission request from the inspection target.

10. The security management device according to claim 9, wherein
the first processing unit inspects the normality of the inspection target based on the acquired information about the inspection target and sends a result of the inspection to the second processing unit; and
if a result of the inspection about the normality of the first processing unit performed after the inspection about the normality of the inspection target is performed shows the first processing unit being abnormal, the second processing unit discards the result of the inspection sent from the first processing unit irrespective of content of the result of the inspection.

11. The security management device according to claim 10, wherein, if the result of the inspection about the normality of the first processing unit performed after the inspection about the normality of the inspection target is performed shows the first processing unit being normal, and the result of the inspection sent from the first processing unit shows the inspection target being normal, the second processing unit sends execution permission to the inspection target.

12. The security management device according to claim 4, wherein the second processing unit executes the inspection about the normality of the first processing unit performed before the inspection about the normality of the inspection target is performed, with receiving of an inspection request from a security management server existing outside the processing device as an execution trigger.

13. The security management device according to claim 12, wherein
the first processing unit inspects the normality of the inspection target based on the acquired information about the inspection target and sends a result of the inspection to the second processing unit; and
the second processing unit sends results of the inspection about the normality of the first processing unit performed before and after the inspection about the normality of the inspection target is performed, and the result of the inspection sent from the first processing unit to the security management server.

14. The security management device according to claim 1, wherein
the first processing unit sends the acquired information about the inspection target to the second processing unit; and
the second processing unit inspects the normality of the inspection target based on the information about the inspection target sent from the first processing unit, and, if a result of the inspection about the normality of the first processing unit performed after the inspection about the normality of the inspection target is performed shows the first processing unit being abnormal, discards a result of the inspection about the normality of the inspection target irrespective of content of the result of the inspection.

15. The security management device according to claim 9, wherein
the first processing unit sends the acquired information about the inspection target to the second processing unit; and
the second processing unit inspects the normality of the inspection target based on the information about the inspection target sent from the first processing unit, and, if a result of the inspection about the normality of the first processing unit performed after the inspection about the normality of the inspection target is performed shows the first processing unit being abnormal, discards a result of the inspection about the normality of the inspection target irrespective of content of the result of the inspection.

16. The security management device according to claim 15, wherein, if the result of the inspection about the normality of the first processing unit performed after the inspection about the normality of the inspection target is performed shows the first processing unit being normal, and the result of the inspection about the normality of the inspection target shows the inspection target being normal, the second processing unit sends execution permission to the inspection target.

17. The security management device according to claim 12, wherein
the first processing unit sends the acquired information about the inspection target to the second processing unit; and
the second processing unit inspects the normality of the inspection target based on the information about the inspection target sent from the first processing unit, and sends results of the inspection about the normality of the first processing unit performed before and after the inspection about the normality of the inspection target is performed and a result of the inspection about the normality of the inspection target to the security management server.

18. A processing device comprising the security management device according to claim 1.

19. A security management method executed by a security management device configured to manage security of a processing device having a normal environment and a secure environment, wherein
first processing unit of the security management device operating in the normal environment acquires information about an inspection target including a program executed in an execution environment included in the normal environment, the inspection target being a target of an inspection about normality; and
second processing unit of the security management device operating in the secure environment inspects normality of the first processing unit after the inspection about the normality of the inspection target based on the acquired information about the inspection target is performed.

20. A non-transitory computer-readable medium storing a program, the program causing a security management device configured to manage security of a processing device having a normal environment and a secure environment to execute the processes of:
first processing unit of the security management device operating in the normal environment acquiring information about an inspection target including a program executed in an execution environment included in the normal environment, the inspection target being a target of an inspection about normality; and
second processing unit of the security management device operating in the secure environment inspecting normality of the first processing unit after the inspection about the normality of the inspection target based on the acquired information about the inspection target is performed.
